(19) United States
(12) Patent Application Publication
(10) Pub. No.: US 2007/0040690 A1
(43) Pub. Date: Feb. 22, 2007

(54) Handheld law enforcement computer

(76) Inventors: Steve Georgalas, Keyport, NJ (US); Christopher Citarella, Manahawkin, NJ (US); James Burrell, Union, NJ (US)

Correspondence Address: Ezra Sutton, Esq.;Plaza 9, 900 Route 9, Woodbridge, NJ, 07095, US

(21) Appl. No.: 11/083,864

(22) Filed: Mar. 18, 2005

(51) Int. Cl. G08B 23/00

(52) U.S. Cl. 340/573.1

(57) ABSTRACT

A hand held computer for law enforcement officers in which to assist their performance of their daily duties. The hand held computer includes a microprocessor, a keyboard and a data input system for entering data into the microprocessor, a display screen and a data output circuit for displaying data from the microprocessor, and a data storage circuit for storing data converted to the microprocessor, and a plurality of control keys for operating in a plurality of modes. The hand held computer further includes a data storage circuit for controlling at least three law conversion functions having at least three law entry keys. The first law entry key is a traffic statute key. The second law entry key is a municipal statute key. The third law entry key is a criminal statute key. The fourth law entry key is a programable statute key. The hand held computer includes a data storage circuit for controlling a phone circuit having a phone control key for entering data regarding a name and phone number for use by the officer.

### FIELD OF THE INVENTION

This invention relates to a portable handheld computer terminal for use by law enforcement officers in order to process and access information, check statutes by numerical code(s) and categories of laws, check court appearance dates for a particular violation(s) by an offender and the like. More particularly, the portable handheld computer would be able to convert a numerical code to an abbreviated statute; convert a statute to a numerical code; separate different laws with a touch of a button for each different category(ies) of law(s); search for a law by putting in the first few letters or numbers of a charge; decipher a numerical code to a written charge; search appropriate court appearance databases for dates for any given municipality; and any other law enforcement associated information or data retrieval. This invention also relates to a portable handheld law enforcement computer terminal with hard wired and wireless communication capabilities used to communicate with headquarters.

### BACKGROUND OF THE INVENTION

Portable computers and similar devices for the storing, printing and dispensing of parking tickets by meter maids, parking officials, and law enforcement officers are well known in the prior art. These devices are well known for storing information and dispensing data, such devices commonly employ a central processing unit (CPU) with peripheral mechanisms for printing and dispensing data.

These aforementioned devices are limited to the issuing of a parking ticket only for a particular vehicle for a given parking violation by the police officer in charge. These portable computers cannot presently aide the law enforcement officer in issuing a ticket for a non-parking violation(s) with regard to the numerical code of a given state statute and the like to an offender for other types of motor vehicle violations such as speeding, reckless driving, DWI, etc.

There remains a need for a portable and handheld law enforcement violation converter (computer) for use by law enforcement officers in performing their every day duties in ticketing/summonsing an offender for a particular violation(s). This law enforcement violation converter would be able to convert a numerical code to an abbreviated statute; convert a statute to a numerical code; separate different laws by use of a touch button for each different category(ies) of law; search for a law by putting in the first few letters of a charge; decipher a numerical code to a written charge; search and find appropriate court appearance dates for a given municipality; and other law enforcement associated information and data retrieval.

There also remains a need for a instant retrieval or transfer of data while law enforcement officers are performing their every day duties. Laptop computers are presently mounted inside patrol cars and cannot be removed and carried, or used while out of the car on foot. The law enforcement officers' only link to headquarters and data is through their 2-way radio/walkie-talkie. This portable handheld law enforcement computer terminal will help law enforcement officers and the like in preparing reports, archiving data, referencing statutes and legal data, networking with other law enforcement agencies, referencing prior to investigations or apprehensions, and the like. The portability of the portable handheld law enforcement computer terminal, the ability to interface with other peripheral devices and the ability to remotely communicate can be utilized to improve the daily work of law enforcement officers.

### DESCRIPTION OF THE PRIOR ART

Parking ticket enforcement systems and portable ticket issuing devices are well known in the art. These devices having various designs, configurations and structures have been disclosed in the prior art. For example, U.S. Pat. No. 4,828,406 to Mosciatti et al. discloses a portable ticket issuing device. This device includes a handheld computer having a keyboard with a display, keys and a handle. This device also includes a ticket storage and dispensing magazine having a manually actable mechanism for dispensing the ticket from dispensing magazine and a printing head for printing the appropriate information on ticket. This prior art patent does not teach or disclose the structure, design, or the method of use of the present invention of a portable handheld law enforcement violation converter for use by law enforcement officers.

U.S. Pat. No. 5,263,118 to Cornelison discloses a parking ticket enforcement system. The system includes a base station computer with a memory for storing a data file representative of vehicle license plate numbers and coded violation information associated with the license numbers. A plurality of stand-alone computers are compatible with the base station computer and have separate memory capacity into which the data file may be transferred. Each stand-alone computer is equipped with voice-recognition circuitry for receipt and recognition of voice communications from an enforcement officer via a handheld unit. The voice communication relates to a license plate number observed by the officer on duty. Upon receipt and recognition of a voice signal by the respective stand-alone computer, the stand-alone computer searches the data file for unpaid violations by the observed number, and if any are detected, the officer is informed so that appropriate enforcement steps may be taken. This prior art patent does not teach or disclose the structure, design, or the method of use of the present invention of a portable handheld law enforcement violation converter for use by law enforcement officers.

U.S. Pat. No. 5,740,050 to WARD II discloses a parking enforcement system. This parking citation issuing and enforcement system includes an electronic citation handheld writing device having a core processing unit therein, and an electronic probe for interacting with the electronic parking member. This prior art patent does not teach or disclose the structure, design, or the method of use of the resent invention of a portable handheld law enforcement violation converter for use by law enforcement officers.

None of the prior art patents teach or disclose the structure, design or the method of use of the present invention of a portable handheld law enforcement violation converter for use by law enforcement officers.

Accordingly, it is an object of the present invention to provide a law enforcement violation converter in the form of a portable, light-weight, handheld computer terminal for use by law enforcement officers in performing their everyday duties in ticketing/summonsing an offender for a particular violation(s) such as a traffic violation, a civil misdemeanor and the like.

Another object of the present invention is to provide a law enforcement violation converter that is able to display data on the computer console such as converting a numerical code to an abbreviated statute; converting a statute to a numerical code; separating different laws by use of a touch button for each different category(ies) of law; searching for a law by putting in the first few letters of a charge; deciphering a numerical code to a written charge; searching and finding appropriate court appearance dates for a given municipality; and obtaining other law enforcement associated information and data retrieval.

Another object of the present invention is to provide a law enforcement violation converter that includes multiple software routines having features such as a law conversion mode, a law questioning mode, a phone mode, a memo mode, a court appearance mode, a calculator mode and a Miranda warning mode.

Another object of the present invention is to provide a law enforcement violation converter that quickly provides to the law enforcement officer pertinent data and information in which to issue a ticket or summons, and/or possibly detain and/or arrest an offender for a given violation.

Another object of the present invention is to provide the law enforcement officer the ability to interface with other peripheral devices and the ability to remotely communicate pertinent data and information in which to perform the law enforcement officer's duties.

A further object of the present invention is to provide a portable handheld computer terminal that can be mass produced in an automated and economical manner; and is readily affordable to various city, county, state and federal law enforcement agencies.

### SUMMARY OF THE INVENTION

In accordance with the present invention, there is provided a hand held computer for law enforcement officers in which to assist their performance of their daily duties. The hand held computer includes a microprocessor, a keyboard and a data input system for entering data into the microprocessor, a display screen and a data output circuit for displaying data from the microprocessor, and a data storage circuit for storing data converted to the microprocessor, and a plurality of control keys for operating in a plurality of modes. The hand held computer includes a first data storage circuit for controlling a court appearance circuit having a court appearance control key for entering data regarding the officer's court appearances; a second data storage circuit for controlling a phone circuit having a phone control key for entering data regarding a name and phone number for use by the officer; a third data storage circuit for controlling a Miranda warning circuit having a Miranda warning control key for displaying the Miranda warning text on the display screen for the officer's review; and a fourth data storage circuit for controlling a calculator mode having a plurality of calculator keys for performing calculator functions by the officer. The hand held computer further includes a fifth data storage circuit for controlling at least three law conversion functions having at least three law entry keys. The first law entry key is a traffic statute key for inserting a traffic statute number inquiry or a key word(s) inquiry related to the statute, and for displaying on the display screen a response to the inquiry. The second law entry key is a municipal statute key for inserting a municipal statute number inquiry or a key word(s) inquiry related to the statute, and for displaying on the display screen a response to the inquiry. The third law entry key being a criminal statute key for inserting a criminal statute inquiry or a key word(s) inquiry related to the statute, and for displaying on the display screen a response to the inquiry. The hand held computer also includes a sixth data storage circuit for controlling a memo mode having a memo control key for entering any personal data or information the officer wishes to store and retrieve later. The hand held law enforcement computer also includes a means to interface with other peripheral devices and the ability to remotely communicate data and information. Using an external memory card port, located in the portable handheld mobile computer for law enforcement, allows the user to transmit and receive data to and from the device.

In one preferred embodiment of the invention, a cover protects the keyboard and the display screen. In another preferred embodiment of the hand held law enforcement computer, the device also includes a means for wirelessly transmitting and receiving data to and from an external source in the form of a walkie-talkie. A GPS circuit integrated into the hand held law enforcement computer is used for indicating the location of the officer or user.

### BRIEF DESCRIPTION OF THE DRAWINGS

Further objects, features, and advantages of the present invention will become apparent upon the consideration of the following detailed description of the presently-preferred embodiment when taken in conjunction with the accompanying drawings, wherein:

FIG. 1 is a perspective view of the law enforcement violation converter of the preferred embodiment of the present invention showing the violation converter in operation al use by a law enforcement officer;

FIG. 2 is a front perspective view of the law enforcement violation converter of the preferred embodiment of the present invention showing the maj or component keys, the upper casement, the lower casement and the front hinged cover;

FIG. 3 is a rear perspective view of the law enforcement violation converter of the preferred embodiment of the present invention showing the lower casement, the battery compartment with battery, the upper casement and the front hinged cover;

FIG. 3A is a flow chart of the law enforcement violation converter of the preferred embodiment of the present invention showing the battery connected to the microprocessor circuit and linked to the data storage circuit, display screen, light, walkie talkie circuit and GPS circuit, where the walkie talkie circuit and GPS circuit are connected to an antenna;

FIG. 4 is a flow chart of the law enforcement violation converter of the present invention showing the major software features of the violation converter system;

FIG. 5 is a flow chart of the law enforcement violation converter of the present invention showing the flow of the software routine for the operational use of the violation converter;

FIG. 6 is a functional flow chart of the law enforcement violation converter of the present invention showing the steps that are carried out for software routine of the law conversion mode feature;

FIG. 6A is a functional flow chart of the law enforcement violation converter of the present invention showing the steps that are carried out for the software routine of the law v questioning mode sub-feature being used in conjunction with the law conversion mode feature;

FIG. 7 is a functional flow chart of the law enforcement violation converter of the present invention showing the steps that are carried out for the software routine of the court appearance mode feature;

FIG. 8 is a functional flow chart of the law enforcement violation converter of the present invention showing the steps that are carried out for the software routine of the phone mode feature;

FIG. 9 is a functional flow chart of the law enforcement violation converter of the present invention showing the steps that are carried out for the software routine of the calculator mode feature;

FIG. 10 is a functional flow chart of the law enforcement violation converter of the present invention showing the steps that are carried out for the software routine of the Miranda warning mode feature;

FIG. 11 is a functional flow chart of the law enforcement violation converter of the present invention showing the steps that are carried out for the software routine of the memo mode feature;

FIG. 11A is a functional flow chart of the law enforcement violation converter of the present invention showing the steps that are carried out for the software routine of the memo mode feature for retrieving a specific memo from the storage memory of the computer;

FIG. 12 is an electrical circuit schematic diagram of the law enforcement violation converter of the present invention showing the electrical circuit of the computer; and

FIG. 13 is an electrical circuit schematic diagram of the law enforcement violation converter with communications capabilities of the present invention showing the electrical circuit of the computer.

### DETAILED DESCRIPTION OF THE PREFERRED EMBODIMENT

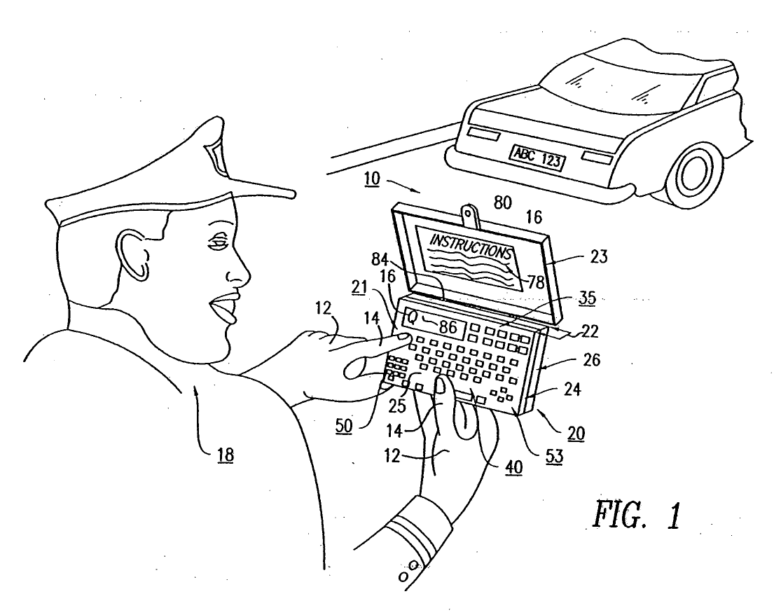

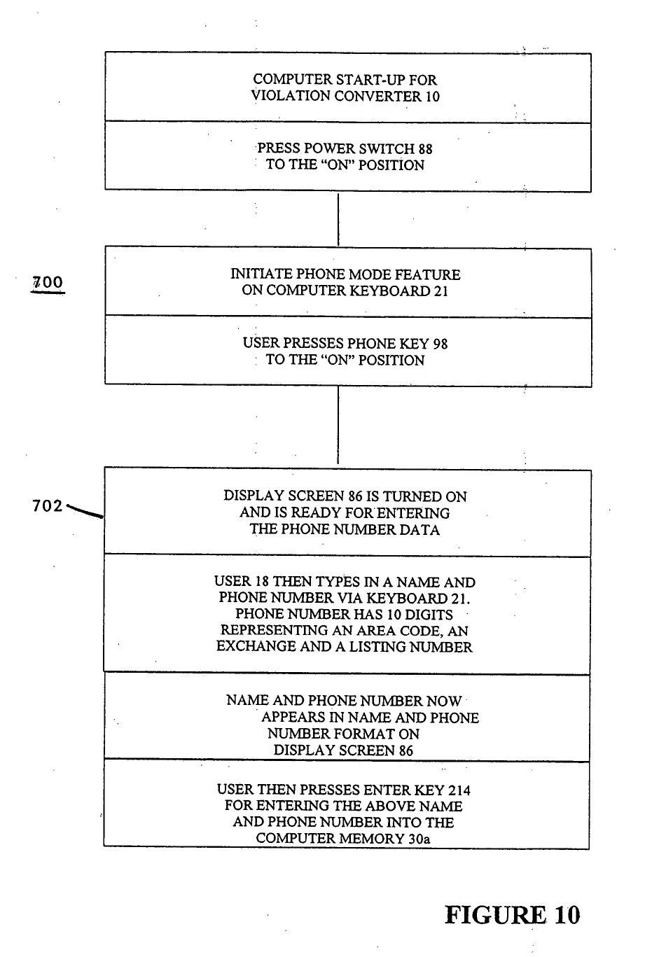

The law enforcement violation converter 10 and its component parts of the preferred embodiment are represented in detail by FIGS. 1 through 12 of the patent drawings. The law enforcement violation converter 10 is used by law enforcement officers 18, highway patrolmen, police, sheriff's officers and the like in order to check statutes by numerical code(s) or by key word queries, categories of laws and court appearance dates for ticket(s) or summons(es). The violation converter 10 is in the form of portable handheld light-weight computer 20 having a manually operated keyboard 21. The violation converter 10 includes a power switch 88, a display screen 86, a light switch 88a, a light 88b to illuminate the display screen, a command section 35, a letter/punctuation section 40, a numeric section 50 and a control section 53. Computer 20 includes a computer housing 22 having a hinged front cover 23, a front/upper casement 24 and a rear/bottom casement 26, as shown in FIGS. 1 to 4 of the drawings. The upper casement 24 includes a front wall 25 and lower casement 26 includes a rear wall 27, and perimeter side walls 28a, 28b, 28c and 28d for forming an interior compartment 29 for holding and placement of computer hardware 30a and software 30b therein.

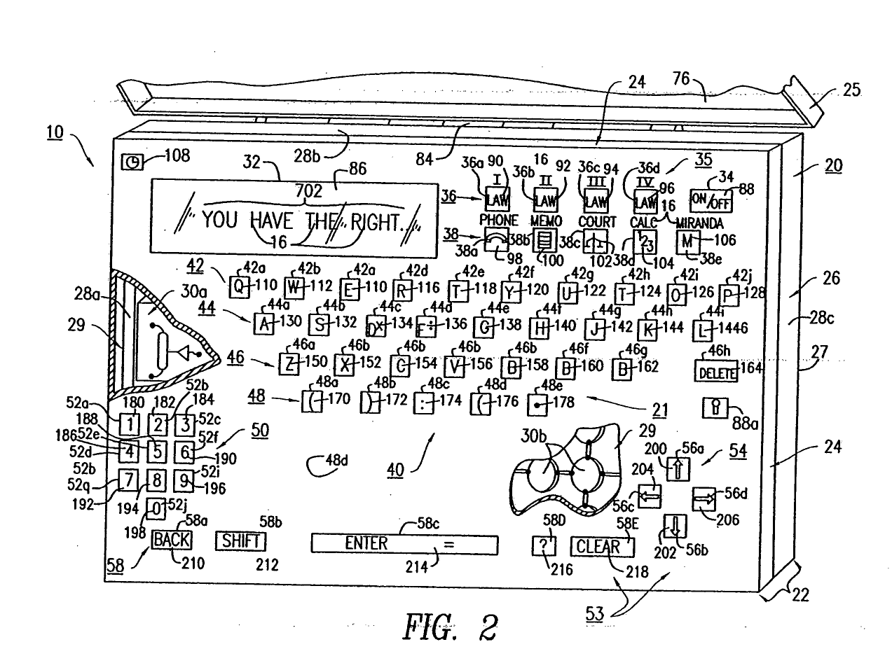

As shown in FIG. 2 of the drawings, front wall 25 of upper casement 24 includes a large rectangular-shaped opening 32 for receiving a display screen 86 therein, and a small rectangular-shaped opening for receiving an ON/OFF switch 88 therein. Command section 35 on front wall 25 also includes a first row 36 having a plurality of square-shaped openings 36a, 36b, 36c and 36d for receiving a [Law I] category button/key 90 representing traffic laws, a [Law II] category button/key 92 representing municipal laws, a [Law III] category button/key 94 representing criminal laws, and a [Law IV] category button/key 96 representing local municipality or county ordinances, respectively, therein; and includes a second row 38 having a plurality of square-shaped openings 38a, 38b, 38c and 38d for receiving a [Phone] number button/key 98, a [Memo] button/key 100, a [Court] appearance button/key 102, a [Calculator] mode button/key 104, and a [Miranda] warning button/key 106, respectively, therein.

Front wall 25 further includes a letter/punctuation section 40, as depicted in FIGS. 1 and 2 of the drawings. The letter/punctuation section 40 has the standard letters of the alphabet thereon, as universally found for computers in the United States. The letter/punctuation section 40 includes a third row 42 having a plurality of square-shaped openings 42a, 42b, 42c, 42d, 42e, 42f, 42g, 42h, 42i and 42j for receiving a [Q] letter button/key 110, a [W] letter button/key 112, an [E] letter button/key 114, an [R] letter button/key 116, a [T] letter button/key 118, a [Y] letter button/key 120, a [U] letter button/key 122, an [I] letter button/key 124, an [O] letter button/key 126, and a [P] letter button/key 128, respectively, therein. The letter/punctuation section 40 further includes a fourth row 44 having a plurality of square-shaped openings 44a, 44b, 44c, 44d, 44e, 44f, 44g, 44h and 44i for receiving an [A] letter button/key 130, an [S] letter button/key 132, a [D] letter button/key 134, an [F] letter button/key 136, a [G] letter button/key 138, an [H] letter button/key 140, a [J] letter button/key 142, a [K] letter button/key 144, and an [L] letter button/key 146, respectively, therein. The letter/punctuation section 40 also includes a fifth row 46 having a plurality of square-shaped 5 openings 46a, 46b, 46c, 46d, 46e, 46f, 46g and a single small rectangular-shaped opening 46h for receiving a [Z] letter button/key 150, an [X] letter button/key 152, a [C] letter button/key 154, a [V] letter button/key 156, a [B] letter button/key 158, an [N] letter button/key 160, an [M] letter button/key 162, and a [Delete] button/key 164, respectively, therein. The letter/punctuation section 40 additionally includes a sixth row 48 having a plurality of square-shaped openings 48a, 48b, 48c, 48d and 48e for receiving a left parenthesis [(] button/key 170, a right parenthesis [)] button/key 172, a colon [:] button/key 174, a hyphen [-] button/key 176, and a period [.] button/key 178, respectively, therein.

Front wall 25 also includes a number/calculator section 50 having the standard arabic numbers in a calculator format, thereon. The number section 50 includes a plurality of square-shaped openings 52a, 52b, 52c, 52d, 52e, 52f, 52g, 52h, 52i and 52j for receiving a number [1] button/key 180, a number [2] button/key 182, a number [3] button/key 184, a number [4] button/key 186, a number [5] button/key 188, a number [6] button/key 190, a number [7] button/key 192, a number [8] button/key 194, a number [9] button/key 196, and a number [0] button/key 198, respectively, therein.

Control section 53 on front wall 25 additionally includes a scroll mode sub-section 54 for enabling the user to scroll in different directions the information being displayed on the display screen 86 when the violation converter 10 is in operational use. The scroll mode sub-section 54 includes a plurality of square-shaped openings 56a, 56b, 56c and 56d for receiving an arrow-up [Δ] button/key 200, an arrow down [∇] button/key 202, an arrow-left 5 [symbol] button/key 204, and an arrow-right [symbol] button/key 206, respectively, therein.

Additionally, control section 53 on front wall 25 includes a last/seventh row 58 having a plurality of rectangular-shaped openings 58a, 58b, 58c, 58d and 58e for receiving a plurality of command keys being a back space [symbol] button/key 210, a [Shift] button/key 212, an [Enter] button/key or equals [=] button/key 214 used as a space bar, a question mark [?] button/key 216, and a [Clear] button/key 218, respectively, therein.

Front wall 25 also includes various text/indicia 16 for formatting and displaying of specific buttons/keys, such as the [Law I], [Law II], [Law III] and [Law IV] buttons 90 to 96, respectively and that of the [Phone], [Memo], [Court] appearance, [Calculator] and [Miranda] buttons 98 to 106, respectively.

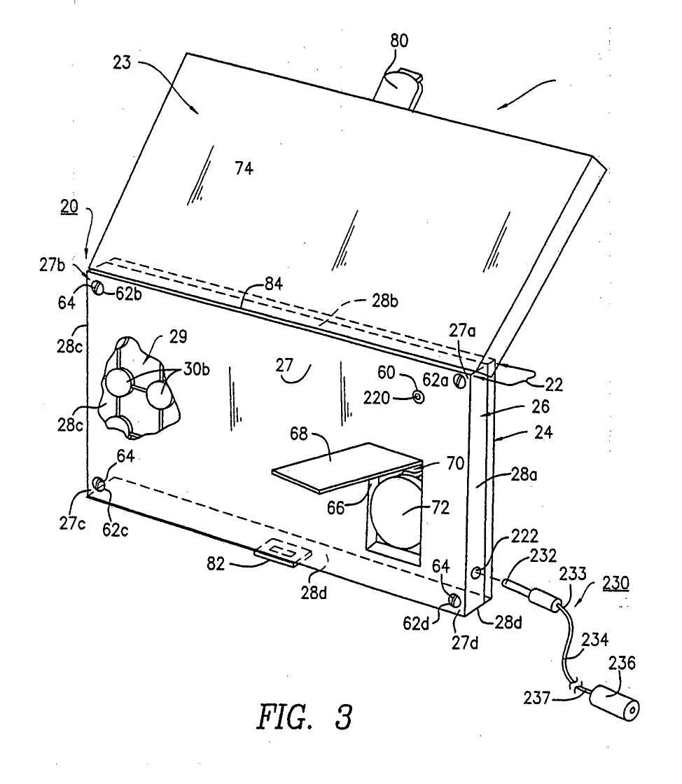

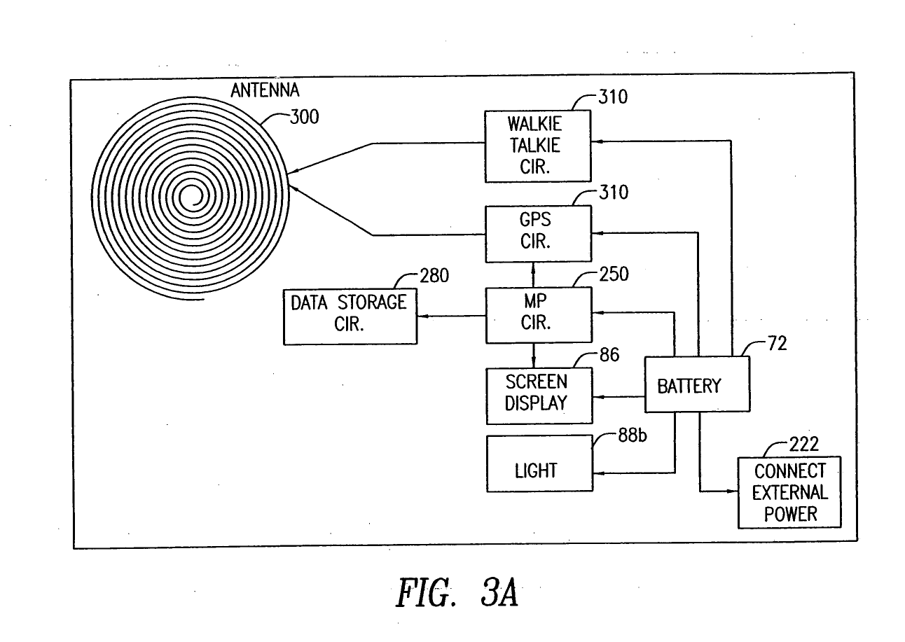

Rear wall 27 of the bottom casement 26 includes a small circular opening 60 for receiving a reset button 220 therein, and a plurality of circular openings 62a, 62b, 62c and 62d located at each rear wall corner 27a, 27b, 27c and 27d for receiving screws 64, respectively, therein. Reset button 220 is used to erase all inputted information being stored in the computer hardware 30a. Screws 64 are used for securing the upper casement 24 and the lower casement 26 with each other, as depicted in FIGS. 1 and 3 of the drawings. Rear wall 27 also includes a large rectangular-shaped opening 66 for receiving a hinged battery cover 68. Interior compartment 29 includes a battery compartment 70 for receiving a battery 72 therein, such that battery cover 68 covers battery compartment 70 when in operational use.

Hinged front cover 23 includes an outer wall surface 74 and interior wall surface 76. Interior wall surface 76 includes an informational sticker 78 thereon for instructing the user on how to operate the violation converter 10. This sticker 78 will have the most needed information, i.e., basic steps, most used keys and their basic functions, different keys to use to get to different functions of the computer 10. Outer wall surface 74 of hinged front cover 23 includes a male latch securing member 80 for receiving with a female latch (insertion) member 82 being located on the perimeter side wall 28d of the bottom casement 26, as shown in FIG. 1 of the drawings. Latch members 80 and 82 are used for connecting front cover 23 with the perimeter side wall 28d of the lower casement 26, as shown in FIGS. 1 and 2 of the drawings. Hinged front cover 23 also includes a hinge member 84 for hingedly connecting front cover 23 with the perimeter side wall 28b of the lower casement 26, as shown in FIG. 2.

As an optional feature, as shown in FIG. 3 of the drawings, violation converter 10 includes charger receptacle member 222 being located on perimeter side wall 28a for receiving the male charger insert plug 232 of a charger assembly 230. Charger assembly 230 includes male charger insert plug 232 at one end 233 of extension cord 234 and a vehicle charger plug 236 at the other end 237 of extension cord 234. A vehicle charger plug 236 connects to a vehicle cigarette lighter (not shown) for recharging of the battery 72 within battery compartment 70, while away from a wall outlet receptacle.

Display screen 86 will be able to hold at least one line of text 16 at a time, wherein at least one line of text/indicia 16 will preferably contain between 20 to 30 data characters (letters or numbers) or text. The display screen 86 will be able to hold at least 15 characters of text 16 at one time, as shown in FIG. 2 of the drawings. Once over the amount of 15 letters and/or numerical characters of text 16 are displayed and shown on display screen 86, the right-arrow [symbol] key 206 will be used to see the remaining characters of text 16 on display screen 86. The display screen 86 will be illuminated by a light 88b for dark conditions for easy reading and typing by the user via the light button 88a, as shown in FIG. 2. ON/OFF switch 88 is the main power button for turning the power “ON” or “OFF” for the violation converter 10 in using the battery 72 for power when operational.

As shown in first row 36, the [Law I], [Law II], [Law III] and [Law IV] keys 90 to 96, respectively, will be used to input appropriate charge(s), retrieve back appropriate state criminal code statutes, or numerical code(s) and vice versa in which this information will be displayed and shown on display screen 86.

As shown in the second row 38, the phone button 98 will be used to retrieve phone numbers of courts which are shown on display screen 86. The memo button 100 will be used to display a title 16 of a given memo and/or the memo text 16 on the display screen 86. The amount of characters used in each memo will be limited due to the memory of the computer hardware 30a. The [Court] button 102 also includes a light for illuminating the display screen 86 and keyboard 21 (not shown) such that when the violation converter 10 is turned “ON” via switch 88 and there is a court appearance date required by the officer 18 for that specific date, the word “Court” will flash on the display screen 86. Once the unit is turned on, the word “Court” flashes before any further commands can be entered into the unit. The court date will be displayed to the user, and then the user can continue. The [Court] button/key 102 will be used in court appearance mode feature 400 to enter court dates, municipality of the court, address, etc. by the user in which this information can be displayed and shown on display screen 86 when needed. The [Calculator] key 104 will be used for accessing the calculator mode 600 of the calculation section 50 where such calculations can be displayed and shown on display screen 86. All major mathematical functions will be represented on shared alphabet keys within the letter section 40. Examples of the mathematical function and shared alphabet keys are as follows: the [+] addition function will be shared with the letter [A] key 130, the [×] times function will be shared with letter [D] key 134, the [÷] division function will be shared with the letter [F] key 136, the [−] subtraction function will be shared with the letter [L] key 146, the [symbol] square root function will be shared with the letter [C] key 154, and the [%] percent function will be shared with the letter [V] key 156. Additionally, the punctuation keys 170, 172, 174, 176 and 178 in the sixth row 48 will also be used in the calculator mode feature 600. While in the calculation mode the pressing of any letter key not designated as a mathematical function will not be able to work or displayed and shown on display screen 86, such that any one of the mathematical characters [+], [×], [÷], [−], [symbol] or [%] being shared and shown in the upper right corner of letter keys [A], [D], [F], [L], [C] and [V]. 130, 134, 136, 146, 154 and 156, respectively, will be the only working character on that shared key. The [Miranda] button 106 will be able to feature the “Miranda” warning text 702 when using the “Miranda” warning mode feature 700 on the display screen 86. The “Miranda” warning text 702 will be programmed within the computer software 3Ob for a given state, as the “Miranda” warning for each state may tend to be different.

The letter/punctuation section 40 includes all significant and commonly used alphabet letter keys 110 to 162, as shown in rows 42, 44 and 46 of FIG. 2 of the drawings, which are utilized as a single function key and not as a shared key or a key with a shift mode. These keys 110 to 162 are singled out for frequent use and are kept separate for easy operation by the user. Keys that have only a single mode (i.e. the colon [:] key 174) and keys that have a shared or split use (i.e. the [A] letter key 130 is shared with the mathematical function of addition (+) when in the calculation mode) are determined by the computer 20 usage and content feature of a particular function. The letter/punctuation section 40 further includes a series of punctuation keys 170 to 178 for use in the proper formatting of statute code or numerical code for a given statute, and the like. The open [(] parenthesis and closed [)] parenthesis keys 170 and 172 will be used many times due to the statutes having an open and closed parenthesis symbol 16 within a numerical code, for example code number 2C:35-10A(1). The parenthesis keys 170 and 172 will also be useful in the phone mode when displaying a phone number in the display screen 86, for example (732) 634-3520 where the parenthesis symbol 16 has enclosed the area code. Further, the open and closed parenthesis keys 170 and 172 will be useful when using memo mode of the violation converter 10, such as entering the offender's name Kenneth Lane in a memo. The colon [:] key 174 and the hyphen [-] key 176 will be used frequently as many statutes use colons and/or hyphen symbols 16 within their numerical statute code, for example code number 2A:10-1C. The hyphen [-] key 176 will be used in many other capacities, such as phone numbers 555-1212, or in a memo mode for a name (Anthony—A.K.A.—Tony). The period [.] key 178 will be used frequently as many statutes use a period symbol 16 within their numerical statute code, for example code number 39:3-4.2. The period [.] key 178 will also be used in the memo mode of the violation converter 10, where the display screen 86 will end a short sentence by the period symbol 16 (example: “Fri. need tie for Crt.”). The period [.] key 178 will also be used as a decimal point symbol 16 in the calculator mode of the violation converter 10, where the display screen 86 will display and show a calculation, such as 3.14+2.15=5.29.

The calculation section 50, as shown in FIGS. 1 and 2 of the drawings, includes a separate area for all of the number keys 180 to 198 when doing mathematical calculations during the operation of the calculation mode 600 of the violation converter 10. As previously mentioned, the calculation mode 600 is operational when the user depresses the calculation [Calculator] key 104 to an “ON” position. The mathematical calculation will appear on display screen 86, as the calculation is being done. Letter keys having mathematical functions thereon 130,134,136,146,154 and 156 are the only active keys within the keyboard section 40 when the calculation [Calculator] key 104 is in the “ON” position. Further, the enter key 214 acts as a total/equals mathematical function during the calculation mode sequence, when the calculation [Calculator] key 104 is in the “ON” position.

The scroll mode sub-section 54 enables the user to scroll the information/text 16 on the display screen 86 in different directions as needed or required when the using the violation converter by the user for a particular function. The scroll mode sub-section 54 includes four arrow button/keys 200 to 206 for operational use by the user. The arrow-up [Δ] key 200 will be used to scroll upwards when searching for information in the performance of a particular function (i.e., the scrolling to find a given statute and its sub-statutes, etc.). The arrow-down [∇] key 202 will be used to scroll downwards in order to further search for information of a particular function. The arrow-left [symbol] key 204 will be used to scroll backwards after using the arrow-right [symbol] key 206 will be used to scroll the text 16 on display screen 86 to the right to see further information that was not able to be seen on display screen 86 because of the limiting size of display screen 86 and/or the amount of text characters 16 being shown in the display screen 86 at one time.

As shown in the last row 58, the back space [symbol] key 210 will be used to move the cursor back, automatically erasing the last text character 16 typed. The back space key 210 can also be used to move the cursor back even if there are no text characters 16 to erase. The [Shift] key 212 will be used to capitalize a given alphabet letter key as previously shown in the keyboard section 40. The enter key 214 will be used to add a blank space between text characters 16 or to request the computer software 30b to perform a specific function (i.e., search for a specific statute 2C:35-10A(1) after its been entered on display screen 86). The [Enter] key 214 will also be used in a dual function capacity as the equal [=] key 214 when the violation converter 10 is in the calculator mode feature. This [Enter] key 214 is an oversized large rectangular key preferably having a different color as compared to the other keys on the keyboard section 40, because of the number of times this key 214 will be used. The question mark [?] key 216 will be used as a single functioning key when it is used in the law questioning mode of violation converter 10. For example, the question mark symbol (?) will be put at the end of a numerical statute to replace text characters that are unknown, such as 30:3? in order to ask the computer software 30a to search and find the correct numerical statute. The question mark [?] key 216 will also be used at the end of a written statute to replace letters/words that are unknown, for example “Failure to?”, where then the computer software 30a searches to find statutes such as “Failure to Stop”, “Failure to Yield”, “Failure to Appear”, “Failure to Pay Fine”, etc. The question mark [?] key 216 will be used for all aspects of searching when using the Law I, II, III and IV mode of the violation converter 10. The clear key 218 will be used to clear and delete any text 16 currently being displayed and shown on display screen 86.

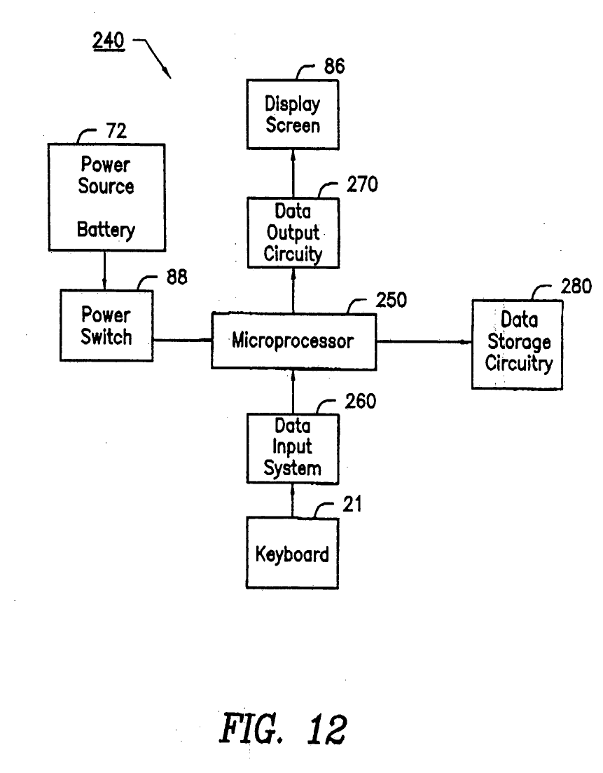

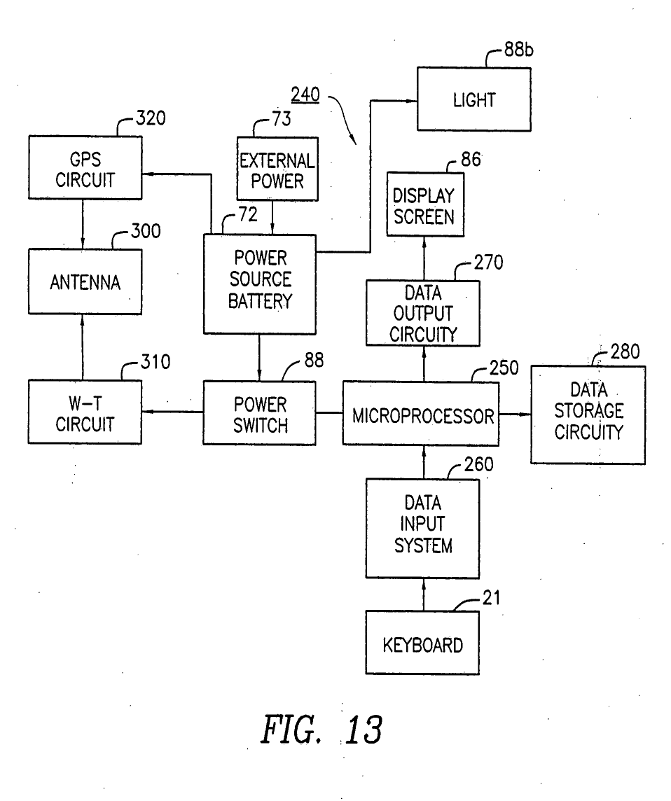

The hand held computer 20, as shown in FIG. 12, depicts an electrical circuit 240 that includes at least one microprocessor 250, the microprocessor being electrically connected to: a data input system 260, data output circuitry 270 and data storage circuitry 280. Power switch 88 turns ON microprocessor 250 and battery 72 supplies the power to operate microprocessor 250. Keyboard 21 is used by user 18 to input information to the data input system 260, so that the inputted information is processed via microprocessor 250 for storing the inputted information to the data storage circuitry 280, as well as, for transferring the inputted information to data output circuitry 270 such that the inputted information is then displayed and shown on display screen 86.

The upper and lower casements 24 and 26 of computer housing 22 is preferably made of durable, non-breakable, moldable plastic polymer. The upper and lower casements 24 and 26 of computer housing 22 is can also be made of bullet proof material such as aluminum or reinforced Kevlar™. The preferred physical dimensions of the computer housing 22 includes a preferable length in the range of 4½ inches to 8 inches, a preferable width in the range of 3 inches to 5½ inches, and a preferable thickness in the range of ½ of an inch to an inch. The preferred physical dimensions of the computer housing will change with memory size, processor speed, periphery devices, antennas, screen size, key size, and the like.

The hand held law enforcement computer 10 also includes a means to interface with other peripheral devices and the ability to remotely communicate data and information. The most common form of connection port presently used is the USB 2.0, but any connection port will do depending upon the required use and function. Using an external memory card port, located in the portable handheld mobile computer for law enforcement, allows the user to transmit and receive data to and from the device. The device may be used by multiple users, therefore using an external memory card port and external memory allows personal information to be temporarily stored in the external memory until the user uses the device again.

The hand held law enforcement computer also includes a means to remotely communicate using a walkie-talkie circuit 310 connected to an antenna 300. In one preferred embodiment of the invention, a cover 23 protects the keyboard 53 and the display screen 86. The cover can be hinged, preferably from the top of the hand held computer, or the cover can be a removable type of cover used to protect the hand held law enforcement computer from the rain and the elements. The cover 23 can be used to display shortcuts, directions or instructions 78 on how to use the hand held law enforcement computer.

In another preferred embodiment of the invention, the hand held law enforcement computer also includes a means for wirelessly transmitting and receiving data to and from an external source in the form of a walkie-talkie. The walkie-talkie hand held law enforcement computer replaces the bulky walkie-talkie used by law enforcement and its non-secure form of audio communication. The walkie-talkie hand held law enforcement computer not only enables a secure form of audio communication but also allows for the instantaneous transmission and reception of data.

A global positioning system (GPS) circuit 320 connected to an antenna 300 is integrated into the hand held law enforcement computer for indicating the instantaneous longitude, latitude, altitude, time and bearing location of the officer or user of the device 24 hours a day.

In another preferred embodiment of the invention, the hand held law enforcement computer can also be a computer program performing the same functions as the physical device. Using the hand held law enforcement computer as a computer program on any standard computer, laptop, PDA, portable computing device and the like allows instantaneous access to information by the officer or the user. The law enforcement computer program uses a plurality of control icons or “hot keys” for operating in a plurality of modes. The control icons or “hot keys” can be touch screen activated, 2-axis mouse activated, voice activated or whatever means required by the operating system or device. A phone icon or phone “hot key” for entering a phone mode is used for entering and retrieving names and phone numbers from the phone book database. A memo icon or memo “hot key” for entering a data entry mode for entering and retrieving alphanumeric data from the microprocessor. A court appearance icon or court appearance “hot key” for entering a court appearance mode for entering and retrieving court information data from a court appearance database. A calculator icon or calculator “hot key” for entering a calculator mode for performing calculator functions.

A Miranda warning icon or Miranda warning “hot key” for entering a Miranda mode for displaying the Miranda warning text on the display screen 10. A plurality of law mode entry icons or “hot keys” are used for entering at least three law data function modes. A traffic statute icon or “hot key” is used for entering a traffic statute number inquiry mode or a key word(s) inquiry mode related to a traffic statute. A municipal statute icon or “hot key” is used for entering a municipal statute number inquiry mode or a key word(s) inquiry mode related to a municipal statute. A criminal statute icon or “hot key” is used for entering a criminal statute number inquiry mode or A key word(s) inquiry mode related to a criminal statute.

### Operation of the Invention

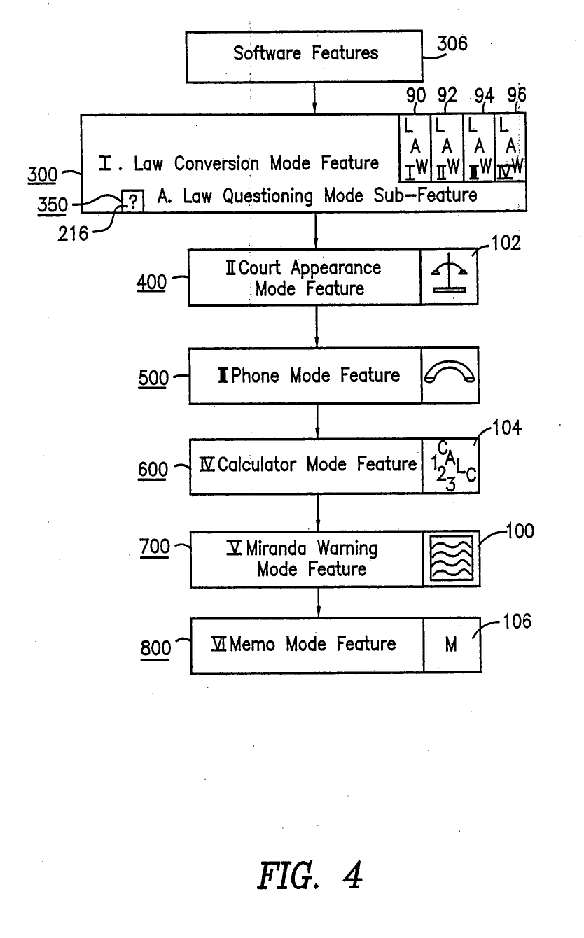

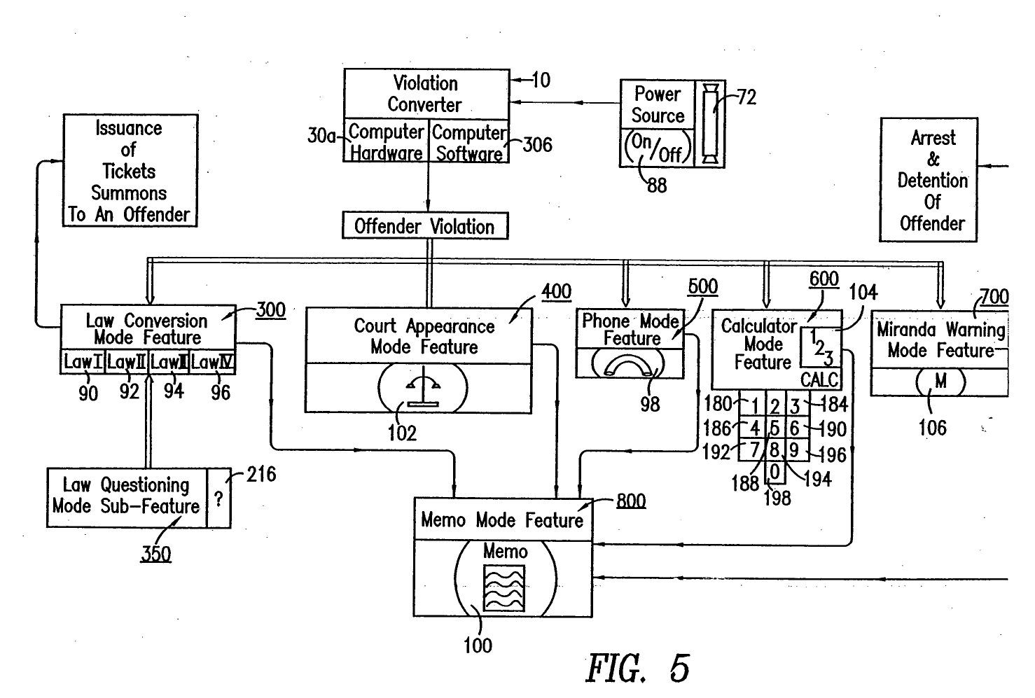

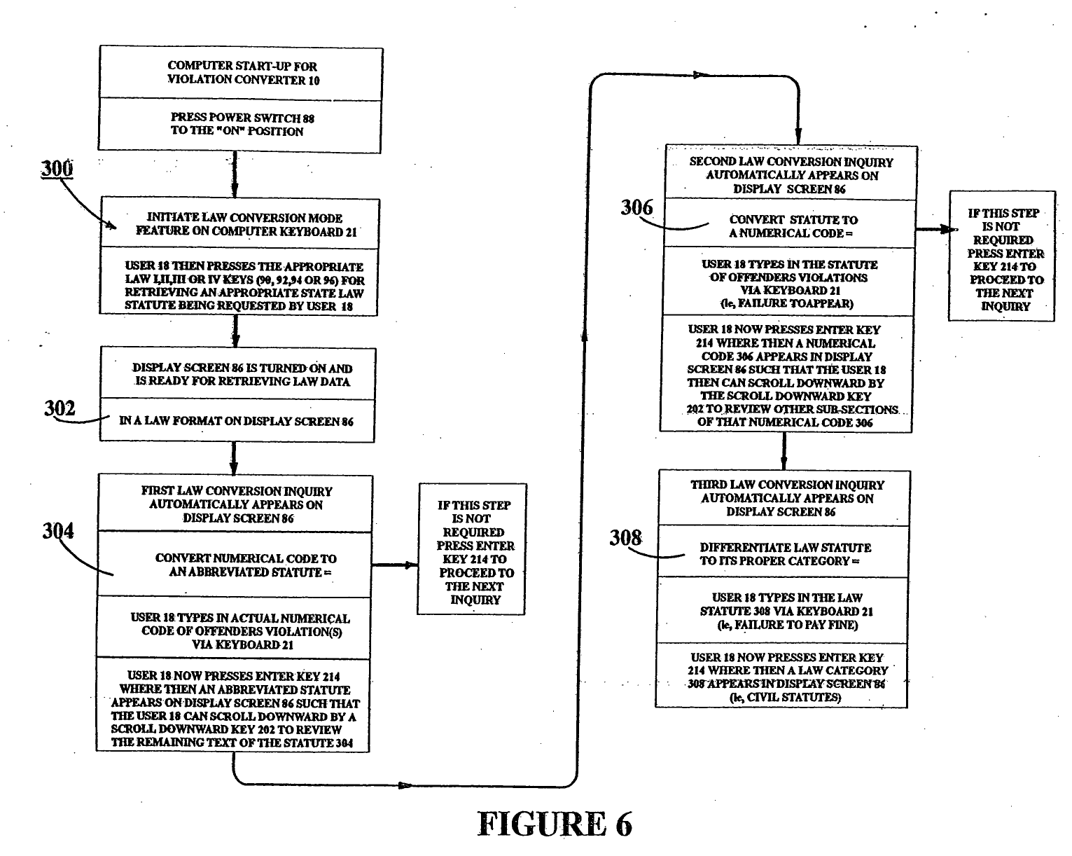

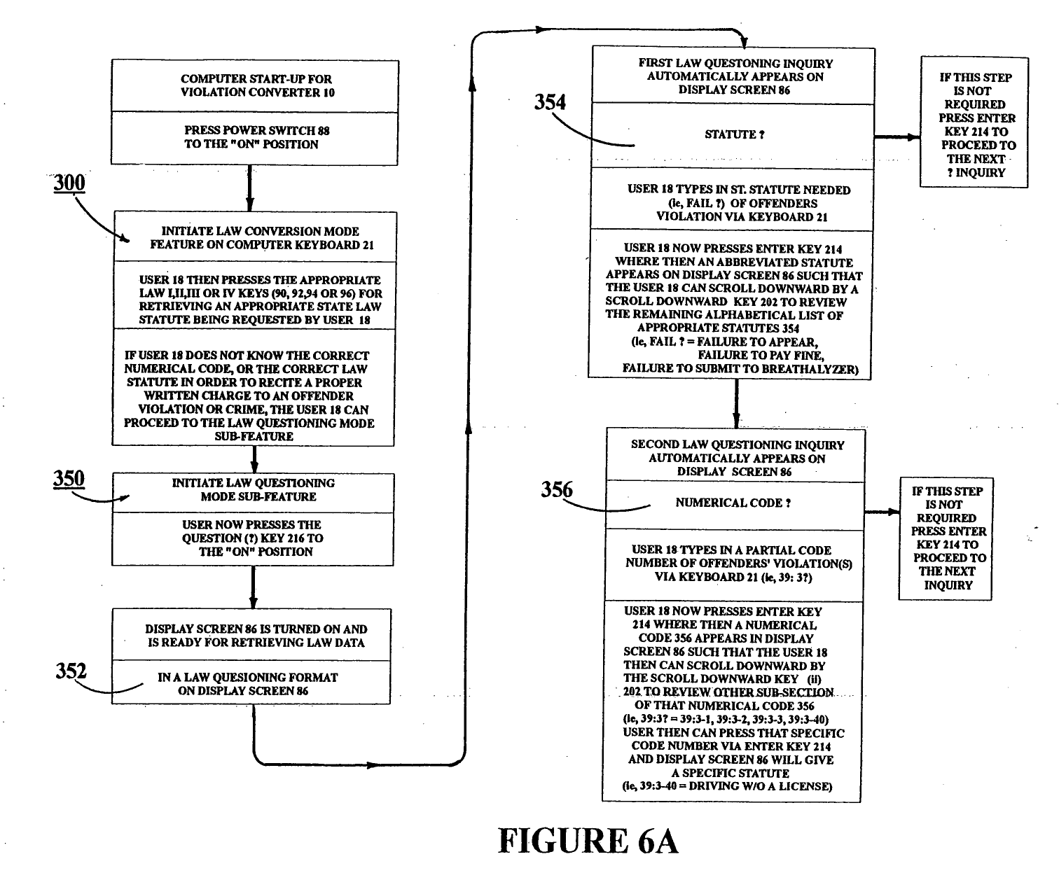

In operation, the law enforcement violation converter 10 is used by law enforcement officers 18 in performing their everyday duties in ticketing/summonsing an offender for a particular violation(s) or a crime, such as a traffic violation, a civil misdemeanor, or a felony which would lead to an arrest and detention. The law enforcement violation converter 10 includes multiple software routines using the computers software memory 3Ob, as shown in FIGS. 4 and 5 of the drawings. These multiple software routines are represented by FIGS. 6 through 11A of the drawings, and include a law conversion mode feature 300 having a law questioning mode sub-feature 350, a court appearance mode feature 400, a phone mode feature 500, a calculator mode feature 600, a Miranda warning mode feature 700 and a memo mode feature 800. To initiate any of these mode features 300,400,500,600,700 or 800, the user 18 simply presses the power switch 88 to the “ON” position, this in turn illuminates the display screen 86 to a ready position, as shown in FIG. 2 of the drawings. Depending upon the needs of the officer 18, the violation converter 10 can be used for a single mode feature or multiple mode features, as depicted in FIG. 5 of the drawings. The user 18 can recharge battery 72 of the violation converter 10 via the charger assembly 230 in the officer's vehicle or at home. Additionally, the user 18 can erase all inputted information within the computer memory hardware 30a for mode features 400, 500 and 800 by depressing the reset button 220 by a tip of a pen in order to activate this function. This is periodically done when computer memory hardware 30a has reached its capacity.

### Law Conversion Mode Feature 300

For the law conversion mode feature 300, the specific operational steps are shown in FIG. 6 of the drawings. In actual use, the user 18 presses the law category keys 90, 92, 94 or 96 in order to initiate the law conversion mode 300 to an “ON” position, where then a series of informational requests will appear on the illuminated display screen 86. The officer 18 then types in the informational request(s) via keyboard 21 in response to each request as displayed in the law conversion format 302 on display screen 86. Each request 304, 306 and 308 is inputted by the user 18, where the enter key 214 is pressed by the user 18 to receive the information requested, as in an abbreviated state statute 304, a numerical code 306 or law category 308, respectively. When using operational step 304, the user 18 can scroll downward via the scroll down [∇] key 202 to review the remaining text 16 of the state statute 304. When using operational step 306, the user 18 can also scroll downward via the scroll down [∇] key 202 to review other sub-sections of that numerical code 306.

### Law Questioning Mode Sub-Feature 350

For the law questioning mode sub-feature 350, the specific operational steps are shown in FIG. 6A of the drawings. In actual use, the user 18 presses the question [?] key 216 after initiation of the law category keys 90,92,94 or 96 (as shown in FIG. 6A) in order to initiate the law questioning mode 350 to an “ON” position, where then a series of informational requests will appear on the illuminated display screen 86, similar in nature to those in the law conversion mode 300, as previously described. The officer 18 uses this mode sub-feature 350 in conjunction with the law conversion mode 300. The user 18 then types in the informational request(s) via keyboard 21 in response to each request as displayed in the law questioning data format 352 on display screen 86. Each request 354 and/or 356 is inputted by the user 18, where the enter key 214 is pressed by the user 18 to receive the information requested, as in a state statute 354 and/or a numerical code 356, respectively. When using operational step 354, the user 18 can scroll downward via the scroll down [∇] key 202 to review various abbreviated state statutes 354 related to the key word inquiry text 16 inputted by the user 18. Once the correct abbreviated state statute is found on display screen 86, the user 18 then presses enter key 214 to review the state statute text 16 of that entry, where then the user 18 can again use the scroll down [∇] key 202 to review that state statute text 16 in its entirety. When using operational step 356, the user 18 can scroll downward via the scroll down [∇] key 202 to review multiple sub-section numerical code number 356 found related to the partial numerical code number 356 inquiry entered. Once the correct and specific numerical code number 306 is found on display screen 86, the user 18 then presses the enter key 214 to see the actual specific statute 304 for that specific numerical code number 306.

### Court Appearance Mode Feature 400

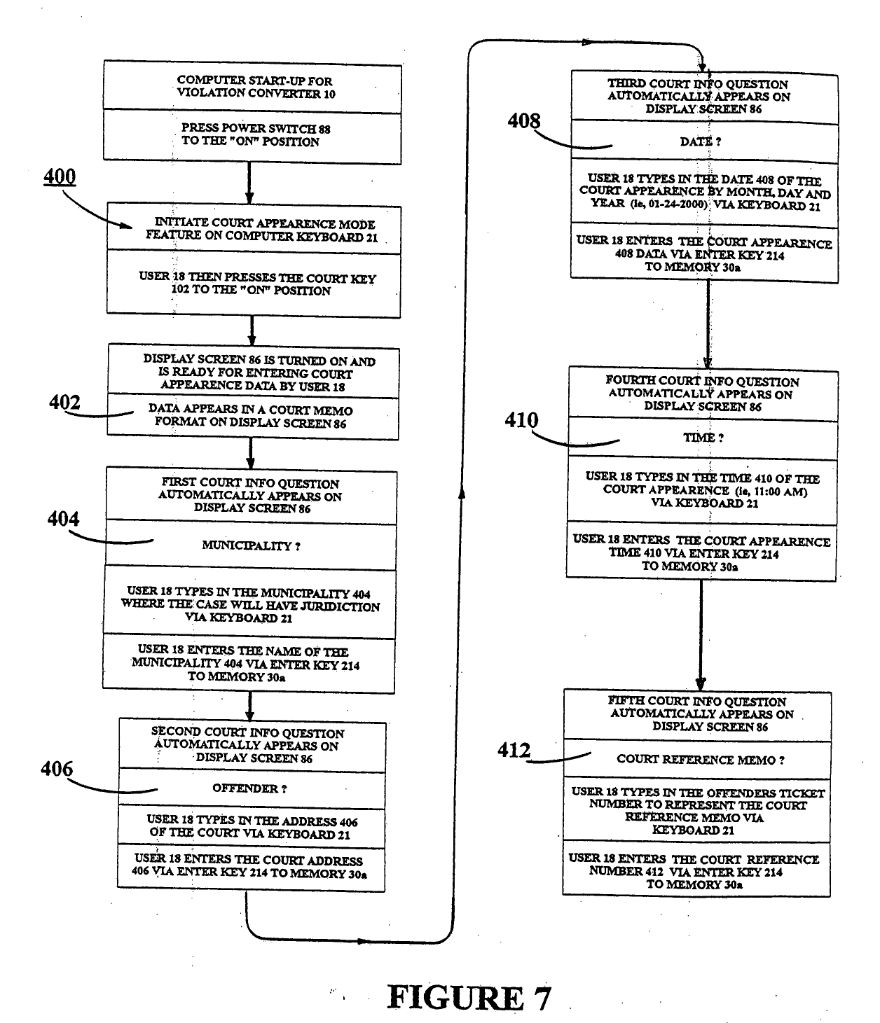

For the court appearance mode feature 400, the specific operational steps are shown in FIG. 7 of the drawings. In actual use, the user 18 presses the court key 102 to initiate the court appearance mode 400 to an “ON” position, where then a series of informational requests will appear on the illuminated display screen 86. The officer 18 then types in the informational/data request(s) via keyboard 21 in response to each request as displayed in the court memo format 402 on display screen 86. Each request 404, 406, 408, 410 and 412 is inputted by the user 18, where then the enter key 214 is pressed by the user 18 after each entry is inputted, such that the next request appears on display screen 86. The information entered by the user 18 goes into computer memory 3Ob of violation convertor 10.

### Phone Mode Feature 500

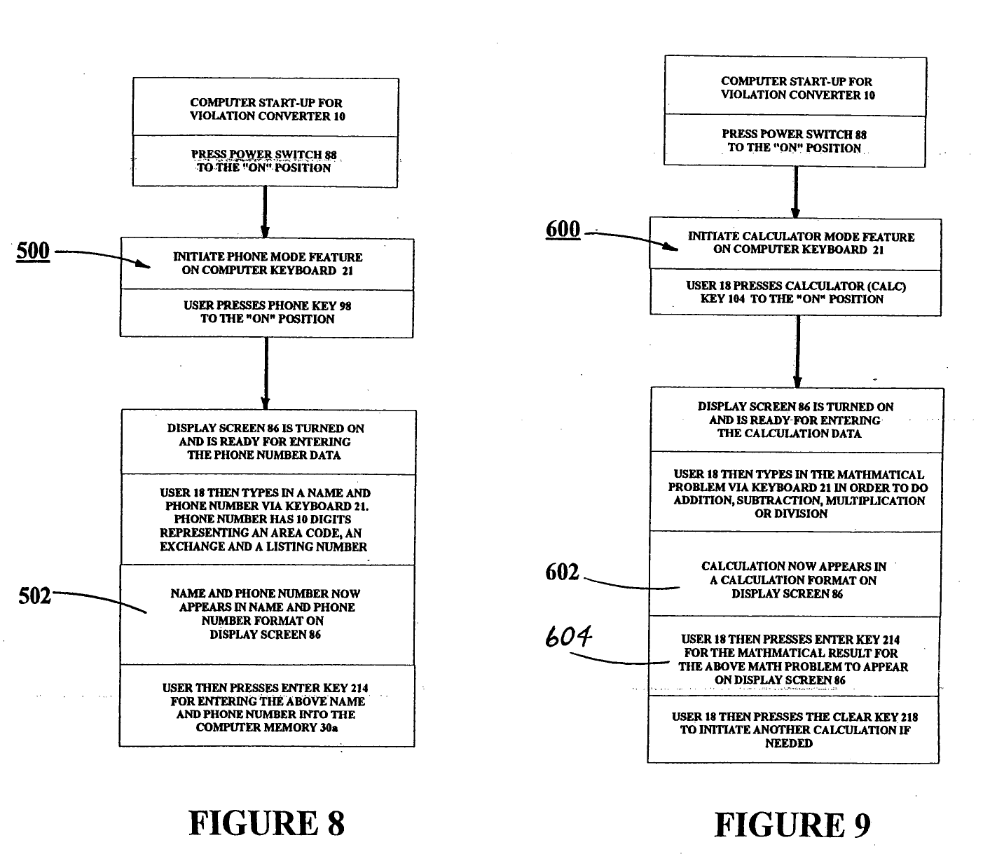

For the phone mode feature 500, the specific operational steps are shown in FIG. 8 of the drawings. In actual use, the user 18 presses the phone key 98 to initiate the phone mode 500 to an “ON” position, where then the informational requests will appear on display screen 86. The officer 18 then types in the name and phone number (10 digits) wanted via keyboard 21 in response to the name and phone number format 502 as displayed on display screen 86. As each name and phone number is inputted by the user 18, the enter key 214 is pressed by the user 18 where then the name and phone number is stored in computer memory 3Ob of violation converter 10. The user can repeat the aforementioned step as needed for the input of other name and phone numbers needed by the user 18.

### Calculator Mode Feature 600

For the calculator mode feature 600, the specific operational steps are shown in FIG. 9 of the drawings. In actual use, the user 18 presses the calculator [Calculator] key 104 to initiate the calculator mode 600 to an “ON” position, where then the user 18 can deploy the number [1] to [0] keys 180 to 198 is a standard fashion for using a calculator. The [A] letter key 130, the [D] letter key 134, the [F] letter key 136 and the [L] letter key 146 are used in the calculator mode 600 for addition, multiplication, division and subtraction, respectively, in performing standard mathematical problems. The mathematical calculation appears in a calculation format 602 on display screen 86 (i.e. 2.12×5.1), where then the user 18 presses the enter key 214 for the mathematical result 604 for the given math problem to appear on display screen 86 (i.e.=10.812). The user 18 then presses the clear key 218 to initiate another calculation if needed on calculator mode 60, and repeats steps 602 and 604 again.

### Miranda Warning Mode Feature 700

The [Miranda] button 106 will be used to access this mode feature 700. The [Miranda] button 106 on the violation converter 10 will be used universally throughout the United States, but the warning itself may be changed for each different state. Once the user pushes the [Miranda] button 106 with his/her finger 14 of the user's hand 12, the computer software 30b will run through the “Miranda” warning text 702, due to the nature and length of the “Miranda” warning 702, only a small portion of the text of this warning will appear on the display screen 86 of the violation converter 10. For example, “You have the right” will appear on the display screen 86, where then the user depresses the arrow-down key 202 and receives further text 702 “To remain silent . . . etc.” on display screen 86. The user can continue scrolling downward on key 202 until all of the text of the “Miranda” warning 702 has been read to a particular offender.

### Memo Mode Feature 800

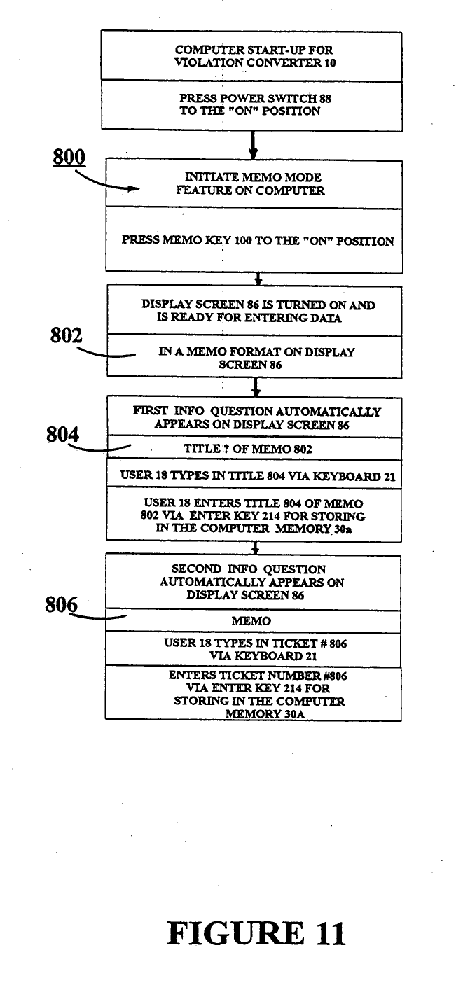

The memo mode feature 800, as shown in FIG. 11 of the drawings, is used by a law enforcement officer 18 to enter pertinent data in a memo format 802 into the computer memory 30a of the computer 20 of the violation converter 10. This pertinent data includes information from a particular ticket(s) or summons(es) issued by the law enforcement officer 18 for a violation by an offender of a specific state law statute(s) for the offense(s) committed I on a specific date. Other information to be included in this memo 802 could be court appearance date(s) if necessary; at what municipal court; type of violation such as civil, domestic, traffic and the like; name of the offender with alias; or phone number of court. prosecutor or offender. All of the aforementioned types of data/information, if necessary, would enter and displayed on display screen 86 as the user 18 systematically enters this data in the computer hardware memory 30a.

In using this memo mode feature 800, the officer 18 simply depresses the memo key 100 with a finger 14 of the user's hand 12, as shown in FIG. 1 of the drawings. This user action then has the computer hardware 30a generate informational questions which are displayed and shown on the display screen 86. The first informational question to appear on display screen 86 is “Title?” 804, the user 18 types in the title 804 of the memo 802 using the letter keys of the keyboard section 40. The user 18 then presses the enter key 214, wherein the title 804 of memo 802 is stored in the computer memory 30a. The second informational question to appear automatically on display screen 86 is “Memo” and the user types in a code number 806 using the keyboard section 40. The user presses the enter key 214 to store this data in the computer memory 30a. More than one ticket number 806 can be displayed on the display screen 86 by scrolling downward via key 202 in which the user 18 types in the next ticket number 406 before the entering and storing of the multiple ticket numbers 806 to the computer memory 30a. It is understood in all of the following steps that the user enters the informational question(s) (if necessary or needed) on the display screen 86, and then the user 18 inputs that information via the keyboard and calculation sections 40 and 50, which enters that information into the computer memory 30a via the enter key 214. The third informational question to appear on display screen 86 is “Violation Date?” 808. The next (fourth) information question to appear on display screen 86 is “State statute numerical code?” 810. The fifth information question to appear on display screen 86 is “Abbreviated Statute Category?” 812 (For example: “Failure to submit to Breathalyzer test”). The sixth information question(s) to appear on display screen 86 is “Offenders Name?” 814, “Offenders Address, Apartment No.?” 816, “Offenders City?” 818, “Offenders State and Zip Code?” 820, The seventh informational question(s) is “Court Appearance Date and Time?” 822, “Municipal Court of?” 824, “Court Address?” 826, “Judges Name” 828, “Prosecutors Name?” 830 and “Violation Type?” 832.

The amount of character text 16 used in each memo 802 will be limited due to the memory capacity of the computer hardware 30a of the violation converter 10. Once the user 18 enters the aforementioned data into the computer hardware 30a, the specific memo 802 can be retrieved by depressing the memo key 100, where then the display screen 86 will show and display the memo 802 by title 804, as each title 804 is alphabetized. The user 18 then scrolls downward with arrow-down [∇] key 202 to find the correct title 804. Once the correct title 804 is found, the user 18 presses the enter key 214. The user 18 is now able to scroll downward again via arrow-down [∇] key 202 to review all of the stored data of that specific memo 802.

### Advantages of the Present Invention

Accordingly, an advantage of the present invention is that it provides for a law enforcement violation converter in the form of a portable, light-weight, handheld computer for use by law enforcement officers in performing their everyday duties in ticketing/summonsing an offender for a particular violation(s) such as a traffic violation, a municipal misdemeanor and the like.

Another advantage of the present invention is that it provides for a law enforcement violation converter that is able to display data on the computer console such as converting a numerical code to an abbreviated statute; converting a statute to a numerical code; separating different laws by use of a touch button for each different category(ies) of law; searching for a law by putting in the first few letters of a charge; deciphering a numerical code to a written charge; searching and finding appropriate court appearance dates for a given municipality that have been entered by the officer and obtaining other law enforcement associated information and data retrieval.

Another advantage of the present invention is that it provides for a law enforcement violation converter that includes multiple software routines having features such as a law conversion mode, a law questioning mode, a court appearance mode, a phone mode, a calculator mode, a Miranda warning mode and a memo mode.

Another advantage of the present invention is that it provides for a law enforcement violation converter that quickly provides to the law enforcement officer pertinent data and information in which to issue a ticket or summons, and/or possibly detain and/or arrest an offender for a given violation.

Another advantage of the present invention is that it provides for a law enforcement violation converter that can be mass produced in an automated and economical manner and is readily affordable to various city, county, state, federal law enforcement agencies, law students, bail bondsmen, court administrators, clerks and the like.

Another advantage of the present invention is that it can also be used as a computer program performing the same functions as the physical device. Using the hand held law enforcement computer as a computer program on any standard computer, laptop, PDA, portable computing device and the like allows instantaneous access to information by the officer or the user.

A further advantage of the present invention is that it provides for a hand held law enforcement computer including a means for wirelessly transmitting and receiving data to and from an external source in the form of a walkie-talkie. The walkie-talkie hand held law enforcement computer allows a secure form of audio communication and the instantaneous transmission and reception of data. A GPS circuit integrated into the hand held law enforcement computer is used for indicating the location of the officer or user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

I claim:

1. A portable hand held mobile computer for law enforcement, small enough to fit in a pocket or carrying case, comprising:
a) a microprocessor;
b) an internal power source for powering said microprocessor;
c) means for connecting said microprocessor to an external power source for powering said microprocessor and for charging said internal power source;
d) an alphanumeric keyboard for entering data into said microprocessor;
e) a data storage circuit for storing data converted to said microprocessor;
f) a display screen;
g) a data output circuit for displaying data from said microprocessor on said display screen;
h) said keyboard having four keys for moving a cursor in four different directions on said display screen;
i) said keyboard having a plurality of control keys for operating in a plurality of modes;
j) a phone control key for entering and retrieving names and phone numbers;
k) a memo control key for entering a text mode for entering and retrieving alphanumeric data;
l) a court appearance control key for entering and retrieving court information data;
m) a calculator control key for entering a calculator mode including a plurality of calculator keys for performing calculator functions;
n) a Miranda warning control key for displaying the Miranda warning text on said display screen; and
o) a plurality of law mode control keys for controlling at least three law data functions on at least three law entry keys:
1) a traffic statute key for inserting a traffic statute number inquiry or a key word(s) inquiry related to said traffic statute for display on said display screen in response to said inquiry; and
2) a municipal statute key for inserting a municipal statute number inquiry or a key word(s) inquiry related to said municipal statute for display on said display screen in response to said inquiry; and
3) a criminal statute key for inserting a criminal statute number inquiry or a key word(s) inquiry related to said criminal statute for display on said display screen in response to said inquiry.

2. A portable hand held mobile computer for law enforcement, small enough to fit in a pocket or carrying, in accordance with claim 1, further comprising:
a cover for protecting said keyboard and said display screen of said portable handheld mobile computer for law enforcement.

3. A portable hand held mobile computer for law enforcement, small enough to fit in a pocket or carrying case, comprising:
a) a microprocessor;
b) an internal power source for powering said microprocessor;
c) means for connecting said microprocessor to an external power source for powering said microprocessor and for charging said internal power source;
d) an alphanumeric keyboard for entering data into said microprocessor;
e) a data storage circuit for storing data converted to said microprocessor;
f) a display screen;
g) a data output circuit for displaying data from said microprocessor on said display screen;
h) said keyboard having four keys for moving a cursor in four different directions on said display screen;
i) said keyboard having a plurality of control keys for operating in a plurality of modes;
j) a phone control key for entering and retrieving names and phone numbers;
k) a memo control key for entering a text mode for entering alphanumeric data;
l) a court appearance control key for entering and retrieving court information data;
m) a calculator control key for entering a calculator mode including a plurality of calculator keys for performing calculator functions;
n) a Miranda warning control key for displaying the Miranda warning text on said display screen;
o) an internal antennae; and
p) means for wirelessly transmitting and receiving data to and from an external source in the form of a walkie-talkie being integrated with said portable hand held mobile computer for law enforcement and connected to said internal power source.

4. A portable hand held mobile computer for law enforcement, small enough to fit in a pocket or carrying, in accordance with claim 3, further comprising:
a cover for protecting said keyboard and said display screen of said portable handheld mobile computer for law enforcement.

5. A portable hand held mobile computer for law enforcement, small enough to fit in a pocket or carrying, in accordance with claim 3, further comprising:
a GPS circuit for indicating the location of said portable handheld mobile computer for law enforcement.

6. A portable hand held mobile computer for law enforcement, small enough to fit in a pocket or carrying, in accordance with claim 3, further comprising:
an external memory card port located in said portable handheld mobile computer for transmitting and receiving data to and from said microprocessor of said portable handheld mobile computer for law enforcement.

7. A computer program for law enforcement comprising:
a) a plurality of control icons for operating in a plurality of modes;
b) a phone icon for entering a phone mode for entering and retrieving names and phone numbers;
c) a memo icon for entering a text mode for entering and retrieving alphanumeric data;
d) a court appearance icon for entering a court appearance mode for entering and retrieving court information data;
e) a calculator icon for entering a calculator mode for performing calculator functions;
f) a Miranda warning icon for entering a Miranda mode for displaying the Miranda warning text; and
g) a plurality of law mode entry icons for entering at least three law data function modes on at least three law entry icons:
1) a traffic statute icon for entering a traffic statute number inquiry mode or a key word(s) inquiry mode related to said traffic statute; and
2) a municipal statute icon for entering a municipal statute number inquiry mode or a key word(s) inquiry mode related to said municipal statute; and
3) a criminal statute icon for entering a criminal statute number inquiry mode or a key word(s) inquiry mode related to said criminal statute.
